(19) United States
(12) Patent Application Publication
(10) Pub. No.: US 2019/0065258 A1
(43) Pub. Date: Feb. 28, 2019

(54) Automatic Provisioning of Load Balancing as Part of Database as a Service

(71) Applicant: ScalArc Inc., Santa Clara, CA (US)

(72) Inventors: Rajkumar Irudayaraj, Los Altos, CA (US); Kulangara K. George, Pune (IN); Varun Singh, Santa Clara, CA (US)

(73) Assignee: ScalArc Inc., Santa Clara, CA (US)

(21) Appl. No.: 15/691,371

(22) Filed: Aug. 30, 2017

(51) Int. Cl. G06F 9/50; G06F 17/30; H04L 29/08

(52) U.S. Cl. CPC G06F 9/505; G06F 17/30297; G06F 17/3048; G06F 9/455; G06F 17/30463; H04L 67/1002; G06F 17/30457

(57) ABSTRACT

A method is described for on-demand creation of a database service. In response to receiving indication that the database service is to be created, an automated process is initiated, including instantiating a quantity of database servers. The database servers include a first subset of at least one of the database servers designated to handle read queries only, and a second subset of at least one of the database servers designated to handle write queries. The process includes determining a quantity and size of load-balancing proxies to instantiate for supporting the database server instance, and instantiating the determined quantity of load-balancing proxies of the determined size. At least one of the load-balancing proxies is a proxy configured to receive database queries and perform query routing among the first subset and the second subset, where one criterion for the query routing is whether a given query is a read or write query.

### FIELD OF INVENTION

The invention relates in general to database as a service, and in particular to a method and system to seamlessly include read/write-aware load-balancing as part of the provided service.

### BACKGROUND

Database as a service (DBaaS) is a service model to provide database users with access to database functionality without the need to set up physical hardware, install software, etc. The administrative tasks of creating and maintaining the database are handled by a service provider. When the database has been created, the database user is given access information for the database, for example an IP address and port number.

Presently available DBaaS systems create database services with varying degrees of configurability. The service provider has or has access to physical or virtual machines and defines a database service among those resources. Depending on the needs of the database user, one or more clusters of database servers will be instantiated, each including one read/write server and some number of read-only servers.

Efficiency of a database cluster can be improved enormously by distributing the workload among the read/write and read-only nodes, a process that can be called read/write-aware load balancing or query processing.

In DBaaS provisioning, database clusters are instantiated, but automated read/write-aware load-balancing capability for those database clusters has not been included. Applicants have recognized a need for a method and system to automate creation and maintenance of database services including load balancing across read and write database servers.

### SUMMARY

A method for on-demand creation of a database service is described herein. Roughly stated, the method comprises, in response to receiving indication from a user that the database service is to be created, initiating an automated process. The process includes instantiating in a virtual environment a quantity of database servers, a first subset of at least one of the database servers being designated to handle read queries only and a second subset of at least one of the database servers being designated to handle write queries; determining a quantity and size of load-balancing proxies to instantiate for supporting the database server instances; and instantiating the determined quantity of load-balancing proxies of the determined size. At least one of the load-balancing proxies is a proxy configured to receive database queries and perform query routing among the first subset and the second subset. One criterion for said query routing is whether a given query is a read query or a write query.

The indication may include identification of a template, the template indicating a performance level for the database service.

The at least one load-balancing proxy may comprise a cache memory and be further configured to: receive, through a network port, a first SQL database query; determine whether the first SQL database query is one for which valid response data is already cached in the cache memory; return the response data from the cache memory if so; and, if not, then forward the first SQL database query through a network port toward one or more of the database servers.

Also described herein is a non-transitory computer-readable medium having stored thereon a plurality of code portions which, when executed by a processor, perform a method for on-demand creation of a database service. The method includes instantiating in a virtual environment a quantity of database servers, a first subset of at least one of the database servers being designated to handle read queries only and a second subset of at least one of the database servers being designated to handle write queries; determining a quantity and size of load-balancing proxies to instantiate for supporting the database server instances; and instantiating the determined quantity of load-balancing proxies of the determined size. At least one of the load-balancing proxies is a proxy configured to receive database queries and perform query routing among the first subset and the second subset. One criterion for said query routing is whether a given query is a read query or a write query.

### BRIEF DESCRIPTION OF THE DRAWINGS

The invention will be described with respect to specific embodiments thereof, and reference will be made to the drawings, in which:

FIGS. 1a and 1b together are a listing of an example command to create a virtual environment to support the read/write-aware load balancing-enabled DBaaS described herein, and verbose output from the command.

FIG. 2 illustrates elements existing following installation of the DCOS environment.

FIG. 3 is a listing of an example command to install the DBaaS described herein following DCOS installation and its verbose output.

FIG. 4 illustrates elements of DBaaS and DCOS following installation of the DBaaS described herein.

FIG. 5 is a listing of an example command to create a user “Bob” in the DBaaS and verbose output.

FIG. 6 is a listing of an example command to create a database service as described herein, and its verbose output.

FIG. 7 illustrates configuration of a distributed database service group including database servers, proxies, and a health monitor.

FIG. 8 is a simplified block diagram of a computer system that can be used to implement features of the DBaaS described herein.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

In a basic database client/server arrangement, one or more database clients can make queries via a network to a back-end database server. The database server executes the queries and returns results to the client that requested them. The clients might be, for example, web servers or application servers or a mix of both. Typically all the clients transmit their queries to a common IP address and port number combination on the database server, and the database server transmits its results back to the IP address that originated each query. Usually an authentication process precedes the queries, in which the client provides the database server with authentication credentials (such as a username and password) and the database server establishes a connection, identified by a connection ID, according to which the client can make its queries. A database server in this basic arrangement is often a single computer system, though in some implementations it might actually be a cluster of computer systems. Even such a cluster, however, is arranged so as to appear to the client as a single server reached via a single IP address and port number combination.

Many more sophisticated database client/server arrangements support the concept of master-slave replication to distribute or spread the load of read/write queries among a plurality of servers. Database servers configured for master-slave replication are said to form a cluster, and operate in sync with each other ensuring that the data between all servers in a cluster is current. One of the advantages that master-slave replication offers is that of allowing the administrators to scale out read performance, without spending excessively on hardware by having to buy a single, more powerful server. The master database server handles all queries that write/manipulate data (insert/update) and the remaining read queries (select) are distributed among the master and the slaves.

Any query or command which does not alter the database in any way, and merely retrieves information stored in the database, is considered a read query, and is typically capable of being processed by both the slave and the master servers; examples of such queries are basic “select” queries, which just retrieve a particular value from a table in the database. Any query or command which may alter or change or delete or add data in the database, or other related meta-data like usernames, passwords, configuration etc. is considered a write query, and can only be handled by master servers; examples of such queries are basic “insert” or “alter” queries which add or modify the data or structure of a table in a database. If a write query were to be sent to a slave server, it would either be ignored or cause the slave database to have a different state of data than the master, and hence fall out of sync, compromising the data integrity of the cluster.

In a typical master-slave database architecture, there are designated master and slave database servers. The master servers are capable of handling both read and write queries, while the slave servers handle the read queries. The replication method most commonly used in a typical master-slave cluster involves the slave database servers reading the logs of transactions on the master servers that store all SQL statements that manipulated the database and executing them locally to ensure that the master and the slave database servers are in sync. Some replication architectures may also utilize a separate replication manager component which monitors the master servers for changes, and, once a change is found, pushes the change to the slave servers, leaving both the master and the slave servers free from the complexity of maintaining sync.

In certain master-slave architectures, the data is stored in a central location (like a SAN), and read from that central location with the aid of a cluster file system. This eliminates the need to perform log based replication, but comes with the additional complexity involved in maintaining a single data store.

Splitting of read-write queries (i.e. directing appropriate queries to appropriate servers in the cluster) that are submitted to master and slave database servers ensures better response time for each of these types of queries. Database servers that handle write queries are optimized for database writes, while database servers that handle read queries are optimized for those. Database servers that are high on memory (RAM) and processor speed can also be configured to handle both read and write queries.

Singh et al., U.S. Pat. No. 8,543,554, “Method and System for Transparent Database Query Caching,” hereinafter the '544 patent; Singh et al., U.S. Pat. No. 8,763,091, “Method and System for User Authentication Offload in a Transparent Database Load Balancer”; Singh et al., U.S. Pat. No. 9,032,017, “Method and System for Transparent Read-Write Query Routing When Load Balancing Databases,” hereinafter “the '017 patent”; and Singh et al., U.S. Pat. No. 8,484,242, “Method and System for Transparent Database Connection Pooling and Query Caching,” all hereby incorporated by reference, describe a proxy (variously referred to in the incorporated patents as a “database accelerator,” “accelerator apparatus,” and “middleware”) that sits between a database client or clients and a cluster of database servers, transparently performing various functions, including load-balancing (also referred to as query routing), authentication offload, and connection pooling. The database client interacts with the proxy as though it were the database itself, and need not have any knowledge of how query processing is handled. There is no need for any modification to the database client to interact with the proxy in place of the database. The received queries may be, for example, SQL queries.

Previously known DBaaS systems provision a database service, including read/write (master) and read-only (slave) servers, but do not include an automated mechanism to establish read/write-aware load balancing, i.e. to receive database queries and perform query routing among the read servers and write servers, wherein one criterion for query routing is whether a given query changes data in the database service. Such a process has not previously been automated.

The term database service is used herein to describe the automated database functionality provided by a DBaaS, including database servers, proxies, and health monitors.

This discussion will describe installing and operating a DBaaS allows for on-demand creation of a database service. Examples will be provided that include the use of known, commercially available and open-source elements and tools, but it will be understood that other platforms and tools could be used instead. For example, the database instances might be Oracle rather than MySQL.

Some prior art read/write-aware load balancing methods require software to be inserted into the client application. The use of a proxy allows for read/write-aware load balancing to be done in a way that is not dependent on any particular environment or type of database server, and can be done without any modification of the database client application.

Often in DBaaS provisioning, there are two parties involved, the service provider and the database user. The service provider has access to the physical and virtual resources necessary to support a database. The database user has a need for a database, for example for an application or a web service. These two parties may be separate entities with a vendor-customer relationship; e.g. the service provider may be an infrastructure provider, while the database user is an independent application developer. Alternatively, these parties may be separate departments within a single organization; e.g. the database administration resources are provided by an IT department while the database services are required by employees in an engineering or research and development department. Other arrangements can be imagined. This discussion will describe a service provider and a database user, but different models are possible. The split of roles and responsibilities may be different than those described. The service provider may own the machines or may lease them from another party. The machines themselves may be local or remote, etc. There may be more parties than a service provider and a database user, or fewer.

The process can be streamlined while retaining flexibility by the use of templates. In an embodiment, the service provider maintains some number of templates, each corresponding to a performance level, or “flavor” of database service. Templates might allow the database user to select among, for example, a small, medium, and large database service; or a database service offering low, average and high performance; or low, average, and high security, etc. A template might correspond to different uses, such as gaming or finance. There may be more options or fewer than those described here, and various concerns, such as speed and size, may be combined. Performance level, as used herein, refers to any aspect of performance, including speed, security, style, etc. The service provider may customize templates to better suit its clientele, and may add new ones. A template may be customized for a particular application. Use of templates frees the user from the need to make many small decisions which require knowledge of database operation (such as the number of CPUs per server, the number of servers, what kind of server, etc.) The database user has only a few choices to make, those choices relevant to his own expertise and needs.

In the examples to come, a template is a file including a set of key-value pairs describing options to be used in creating the database service. In embodiments, templates are defined in declarative syntax, specifying the result to be achieved rather than spelling out the process to achieve those results. A template may be implemented in a variety of ways. In choosing a template a user may be, directly or indirectly, selecting a list of options, one or more code fragments, one or more sequences of SQL statements, etc.

The database service will be configured according to the template chosen. A “large” database service, for example, may have more database servers, or more CPUs per server, or more disk or dynamic memory, than a “medium” or “small” one. A “high” security database service may come with more encryption than a “low” security one, or may include the use of SSL, and so on.

In the embodiments to be described, creation of the database service is API-driven. There may be a simplified front end presented to the user, such as a command-line or graphical user interface which is simpler and more streamlined than API calls. A command line interface called dbaascli will appear in the examples to come.

An example will be provided of creation of a database service that includes automated provision of load balancing across read/write and read-only database servers. In the example, the first step is installation of DCOS, an operating system to support distributed applications, followed by installation of Marathon and other services to support DBaaS to the existing DCOS cluster. In the example, these steps are initiated by the service provider, and may be performed only once. Once these steps have been performed, the tools and environment are in place for the service provider to customize templates, and to create and manage accounts for database users. Once a database user has an account, the user can then use the provided DBaaS tools to, on demand, create and destroy database services which include a load-balancing proxy to transparently perform read/write-aware query routing.

The example will describe installing DCOS into an AWS environment. Those skilled in the art will appreciate that the example is provided for clarity, but is just one of many possible implementations. A sequence will be described, but the actual steps may be different, in a different order, or performed by different parties.

### DCOS and DBaaS Environment Setup: Service Provider

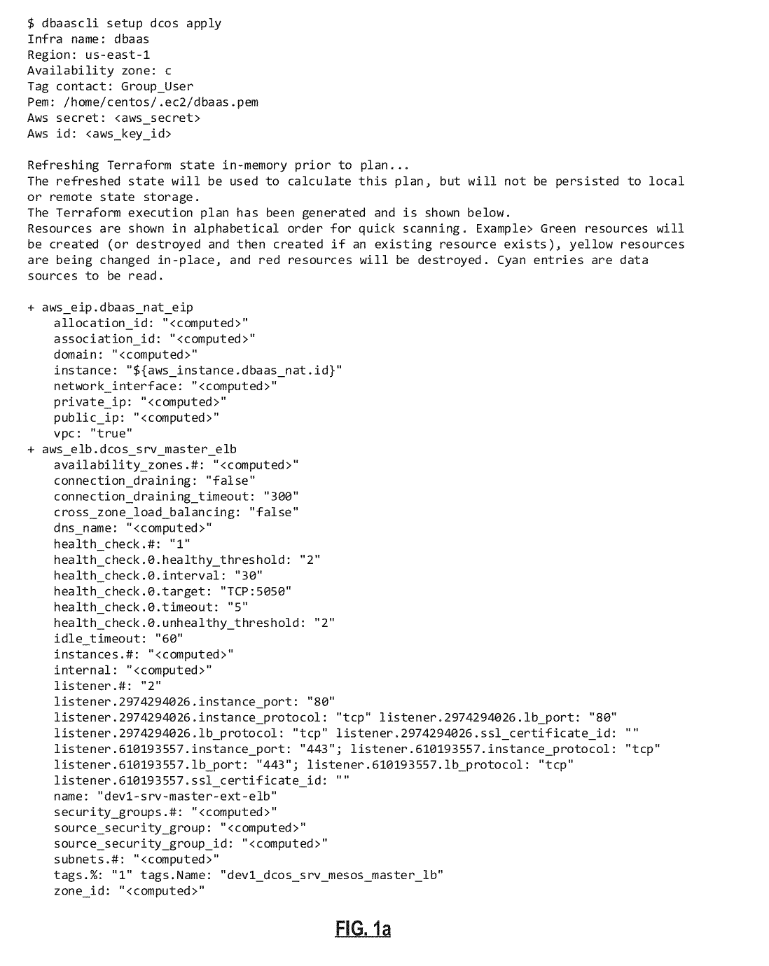

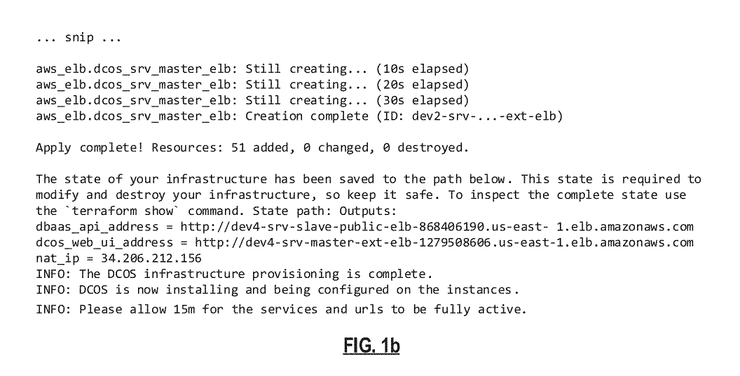

In an embodiment, the service provider installs a command line interface, in this example called dbaascli. The service provider then issues a dbaascli command to install DCOS. FIGS. 1a and 1b show a partial transcript of the command and its verbose output. In this example, the command is as follows:

$dbaascli setup dcos apply

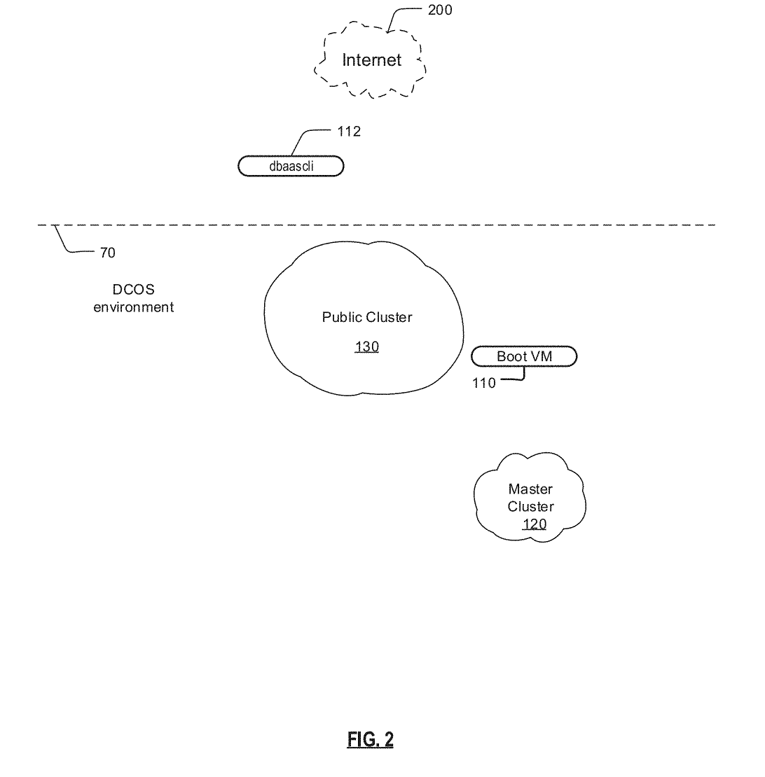

Referring to FIG. 2, this command creates Boot VM 110, master cluster 120 and public cluster 130. The dbaascli 112 was installed earlier. Boundary 70 delineate the private/public divide between the DCOS environment (below boundary 70) and the outside world (above). The DCOS environment also includes some number of additional virtual machines, not shown. As will be seen, these additional virtual machines will support containers that handle the internal workloads, for example of the database services to be created.

Master cluster 120 consists of three or more virtual machines tasked with running DCOS internal services, such as DNS, job schedulers, and task runners. Master cluster 120 is not available for user services or access. Public cluster 130 is addressable from the outside world, for example via the internet, and will provide access to containers running within the DCOS that are addressed from outside.

The DCOS provides a virtual environment in which the DBaaS will later instantiate elements of a database service. To “instantiate” an object is to create an instance of that object, where its characteristics are previously defined.

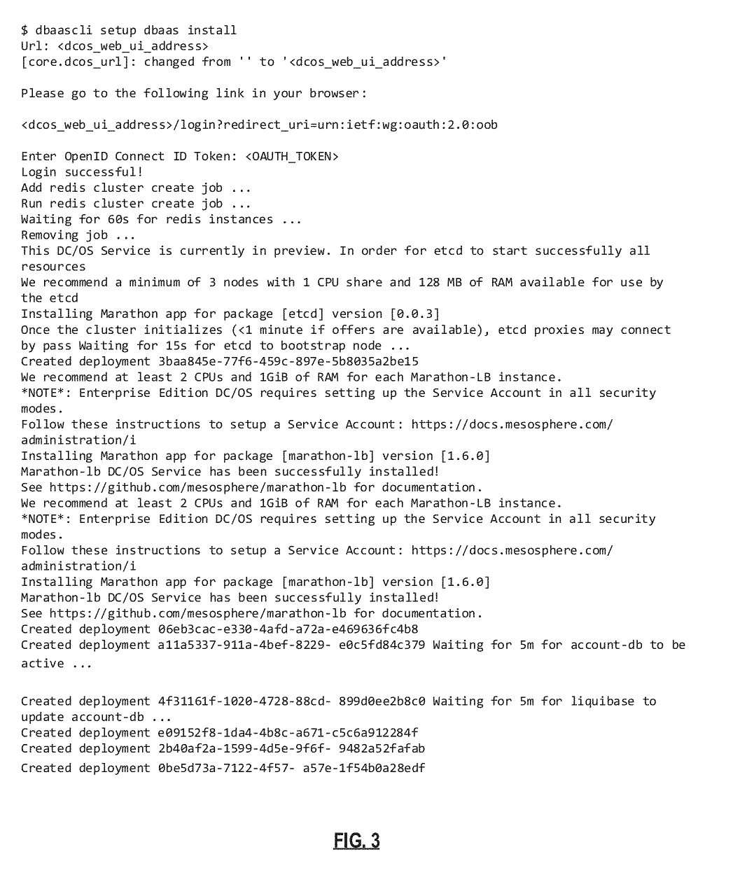

In an embodiment, next the service provider uses dbaascli 112 to install services to support the load-balancing-enabled DBaaS described herein. FIG. 3 shows the verbose output of a command to do so, in this case the following command:

$dbaascli setup dbaas install

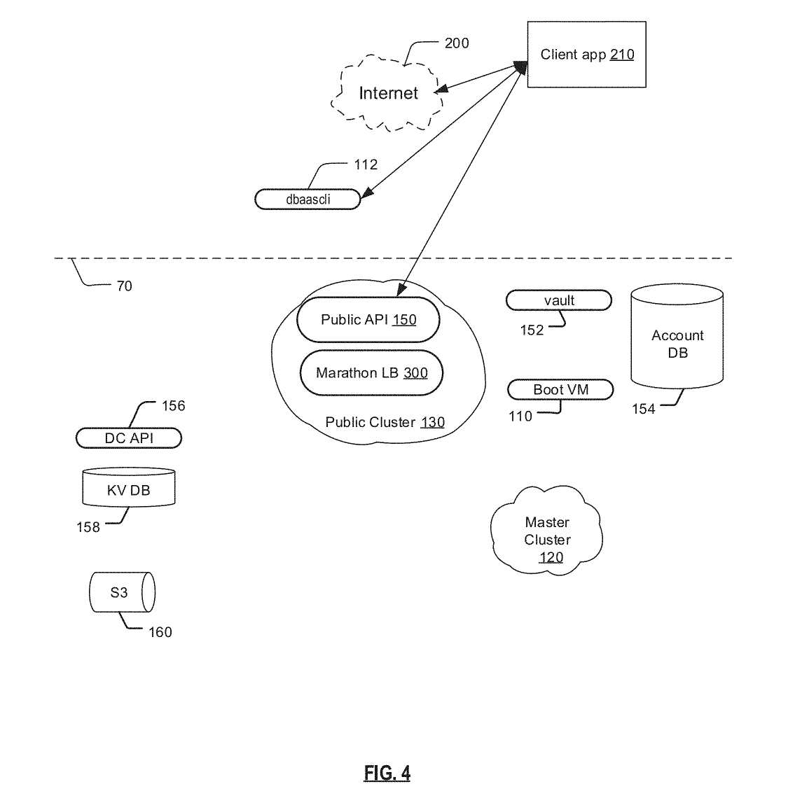

Referring to FIG. 4, at this point, in the present example, additional elements are created. Public API 150 is created in public cluster 130 and can be called by a database client 210, which may be, for example, an application. In the example provided, dbaascli 112 provides a front end to Public API 150, but, alternatively, a client, application, or user may call routines within Public API 150 directly. Client 210 communication can also come by way of internet 200. Other elements are created at this point which are not accessible to the outside world, including: vault 152, which secures, stores, and controls access to tokens, passwords, certificates, API keys, etc.; Account DB 154, which stores all user and account information, group/project and account hierarchies, API permissions, etc.; DC API 156, which contains the primary handler for all of the API endpoints; S3 160, a storage service; and KV DB 158, cluster-specific configuration key-value data for my.conf, etc. A DBaas etcd cluster (not shown) is also created. KV DB 158 is stored in the etcd cluster. These elements are created on various virtual machines in the DCOS environment.

In an embodiment, Marathon load balancer 300 is installed in public cluster 130 in response to the $dbaascli setup dbaas install command. Marathon load balancer 300 provides service discovery to clusters within the DCOS, transparently forwarding connections to dynamically assigned host/port combinations of the individual Marathon application instances and allowing clients to connect to a defined service port without needing to know the implementation details of discovery. Note that Marathon load balancer 300 exposes services to outside applications; it does not perform read-write/aware load balancing, distinguishing read and write queries and distributing the queries appropriately across read and write servers.

### Template Customization: Service Provider

If templates are being used, the service provider may customize them, either modifying them or creating new ones. Templates may be implemented as key-value pairs specifying selected aspects of a database service to be created. For example, small, medium, and large templates may be implemented as follows:

### Small:

name: small

mem: 1024

volume_size: 1024

type: pxc

cpus: 1

instances: 3

### Medium:

name: medium

mem: 2048

volume_size: 1024

type: pxc

cpus: 2

instances: 3

### Large:

name: large

mem: 4096

volume_size: 1024

type: pxc

cpus: 4

instances: 3

In the small, medium, and large example templates above, key-value pairs specify various aspects of a cluster of database servers to be created in the database service. The amount of dynamic memory per database server (mem) is expressed in megabytes, and thus in this example is 1024, 2048, or 4096, which is equivalent to 1, 2, or 4 gigabytes per server, respectively, for a small, medium or large cluster. The number of CPUs per database server is, respectively, 1, 2, or 4; and the disk space (volume_size) per server is also expressed in megabytes, or 1 gigabyte for all three templates. In all three example templates, the type of cluster is pxc, indicating a Percona XtraDB Cluster (PXC). In all three, the cluster consists of three servers, as defined by the instances: 3 key-value pair. Typically this will be one write server and two read servers. These are examples, and templates can be very different from those shown. They can be formatted differently, can include different keys and different values, there can be more or fewer defined values, more or fewer templates, etc. The values provided by the template serve as parameters to modify the automated process to create the database service.

Templates may be presented to a database user in any suitable manner. For example, the service provider may develop a curated catalog of templates available for selection by database users. By limiting the choices to a set of pre-approved options, the process of creating a database becomes easy for the database user. For the service provider, since the outcomes are limited, providing resources required by the database services created using the DBaaS becomes predictable and automatable.

Once the elements shown in FIG. 4 have been created and templates have been customized by the service provider, the DBaaS is in place and ready for use to create a database service. The steps performed so far need be performed only once to ready the DBaaS environment, as opposed to the steps that follow, which may be performed once per database user, by the service provider; or once per database service, by the database user. Note that the service provider may, however, choose to perform any of these steps more than once, say to uninstall and reinstall DCOS or the DBaaS environment, or to further modify templates or create new ones.

This description began the process with installation of DCOS. If a DCOS environment is already in place, the DCOS installation step can be skipped, and the DBaaS described herein can be installed into the existing DCOS environment.

### Database User Account Management: Service Provider

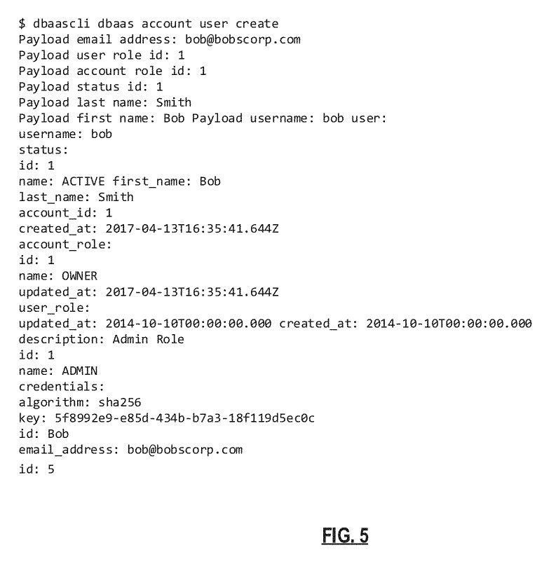

When a database user wants to use the DBaaS to create a database service, the service provider may use dbaascli commands to create an account to make the database user an authorized user of the DBaaS. A verbose transcript appears in FIG. 5 of a user named “bob” being created. In this example, the user “bob” is created with an Admin role, though other roles may be selected.

Referring to FIG. 4, this command creates user credentials, which are stored in vault 152 for later verification. User information is stored in Account DB 154.

Other commands will be available to the service provider to manage database user information, such as display, revoke, delete, etc.

When the database user is fully created, he will be given credentials, in this case including an ID (“Bob”) and a key, which serves as a password. In other configurations, different credentials may be given. Once the database user has the necessary credentials so he will be known to the DBaaS, the database user is ready to create a database service.

### Database Service Creation: Database User

Before using the DBaaS environment and tools to create a database service, a database user with DBaaS credentials may need to first download and install the command line interface dbaascli 112 or some other user interface. He may be provided with a URL to do so.

In the present example, the database user selects a template. As described earlier, the templates free the database user from the need to make multiple small decisions about the configuration of the database service. The service provider may choose to provide a mechanism for a sophisticated database user, who has the knowledge and the need to do so, to request changes to templates, to modify them, or to bypass templates and provide configuration information directly.

A database user who is developing a new application may or may not already have a database schema and seed data defined for the database to be created. If the schema of the database is as yet unknown, as may be the case in the first creation of a database service during a development cycle, there is no need to provide database schema and seed data, and an empty database will be provisioned. If, instead, the database user has a database schema and seed data defined, these can be provided so as to be used during creation of the database service. Database schema and seed data can be specified in one or more SQL files. The SQL file or files can be provided in a variety of ways, for example as parameters to the command that creates the database service, by placing the files in a known location, by modifying the template to include a pointer, etc. In some embodiments, a standard template is used by a database user the first time to create a database service including an empty database with no predefined schema. Once the database schema is known, the template is modified, creating an application-specific template that includes a reference to an SQL file or files specifying schema and seed data for that application. The files can be modified as application development proceeds.

With these elements in place, the database user can create one or more database services on demand, with creation and destruction of database services controlled by the database user.

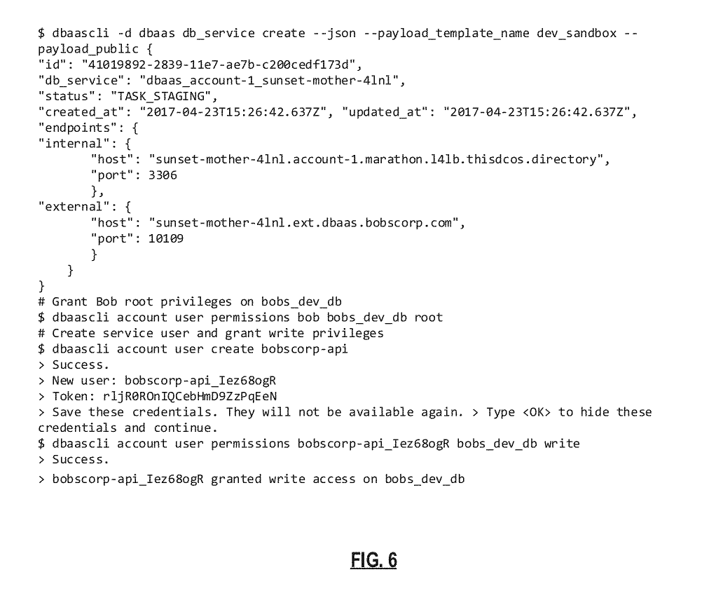

FIG. 6 shows the verbose output of the dbaascli command used by a user, Bob, to create a database service:

$dbaascli dbaas db_service create

In the present embodiment, this command serves as indication from the database user that a database service is to be created by an automated process. The automated process to create the database service is modified by parameters supplied with the indication that the database service is to be created, for example by the choice of a template. Other means may be used to supply such parameters as well or instead.

With the command, the user provides his credentials. The credentials may be parameters to the command line, or may be provided in a file which is input to the command. In the example shown in FIG. 6, for example, the credentials are in a default JSON file readable by dbaascli. This avoids having the key appear in plain text.

Referring to FIG. 4, the command line interface dbaascli 112 passes the command to Public API 150, which verifies the user's credentials with vault 152 (where they were created earlier by the service provider.) If the credentials are not verified, the process is terminated. Valid credentials allow Public API 150 to look up the user in Account DB 154 to verify permissions. If all permissions are valid, Public API 150 passes the request to DC API 156.

The db_service create command initiates an automated process. During the automated process, no significant additional user configuration is required. The process goes forward without ongoing direction by the database user and service provider. A party provides “ongoing direction” to a process by supervising the process and making decisions during the process that will have a significant impact on the final configuration of the database service. An automated process may report progress to a user, and even require some input, such as permission to proceed with certain steps. This sort of limited interaction does not constitute “ongoing direction.”

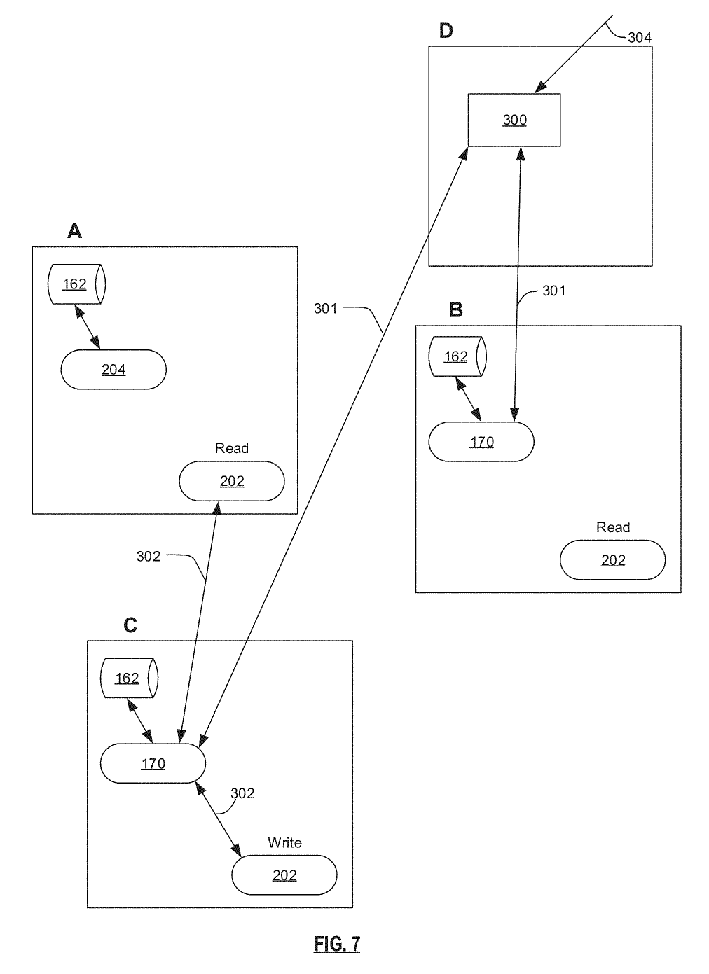

Turning to FIG. 7, during the automated process, a database service group (DBSG) is created. A DBSG includes a cluster of database servers 202, a health monitor 204, and at least two load-balancing proxies 170. The cluster of database servers 202 includes a first subset of at least one of the database servers designated to handle read queries only and a second subset of at least one of the database servers being designated to handle write queries. The cluster (which may be, for example, a PXC, may include three or more database servers.

As described earlier, within the DCOS some number of virtual machines form a master cluster, which handles DCOS services. There are also several additional virtual machines. Generally several of these virtual machines make up the public cluster. Within the DBSG, an etcd 162, a distributed data store, will be used to keep track of health, role, and other information about the database servers. An etcd requires a minimum of three nodes to be redundantly deployed. Referring to FIG. 7, then, the containers of a DBSG are instantiated across at least three virtual machines. The example to follow will show a DBSG created across three virtual machines, though in some embodiments there will be more than three.

In an embodiment, three virtual machines A, B, and C are selected from among the available virtual machines. The virtual machines used may be selected to best distribute workload. As an example, to instantiate a database cluster having three database servers, first an etcd instance 162 of an etcd cluster is created on each of virtual machines A, B, and C. Next one of the database servers 202 is instantiated on one of virtual machines A, B, or C. Information about the first database server 202, including IP address, is placed in etcd store 162. Next health monitor 204 and the other two database servers 202 come up in parallel. Each database server 202 runs on a different one of the virtual machines A, B, and C. IP address for the remaining database servers 202 are also registered in etcd store 162. The same information is stored in all three instances of etcd 162, and an update to one is automatically mirrored to the other two.

Finally at least two instances of the read/write-aware load-balancing proxy 170 are instantiated, each on a separate one of the three virtual machines A, B, and C, completing the DBSG. When provisioned, proxies 170 are registered with the Marathon load balancer 300, which is shown running on virtual machine D. Virtual machine D is in public cluster 130 (shown in FIG. 4.) The host and port number for the DBSG are provided as output from the db_service create command. The command, shown in FIG. 6, produces internal and external host and port number. The internal host and port number can be used by a client within the DCOS environment, while the external host and port number are to be used by a database client outside the DCOS environment. Traffic from a database client inside the DCOS environment may be routed through an internal Marathon load balancer, not shown.

The number and characteristics, such as size, of the load-balancing proxies 170 to instantiate for supporting the database server 202 instances are automatically determined from the size and requirements of the database cluster. One formula, for example, provides for one proxy CPU to be provisioned for each eight database server CPUs (where each server or proxy may have multiple CPUs), with a minimum of four CPUs per proxy. For example, a database cluster with three database servers 202 having two CPUs each has a total of six CPUs. The eight-to-one ratio then dictates one CPU per proxy 170. But since the minimum is four, there will be four CPUs per proxy 170. In a database cluster with five database servers 202 having eight CPUs each, there will be a total of forty CPUs; thus the eight-to-one ratio dictates there will be five CPUs per proxy 170. The detailed example provided shows two proxies 170, but two is a minimum, and there may be more.

In the cluster shown, the servers 202 are labeled with their roles: The server 202 on virtual machine C is a write server, while the other two are read servers. The roles of the database servers 202 are assigned and stored in the etcd 162 as well, as is the status of each database server 202, e.g. whether the server is online. In a three-node cluster, typically one database server 202 is a write server and the other two are read servers. Distributing the database servers and proxies across different virtual machine makes it less likely that more than one database server 202 or more than one proxy 170 will fail at the same time.

Database servers 202 may be, for example, MySQL instances. In embodiments the MySQL servers, health monitor 204, and the proxies 170 will be instantiated as containers and thus will be operating-system agnostic.

With the host and port numbers provided in response to the db_service create command, the database user now has access to the database, and can begin using it. In embodiments, the service provider handles administrative tasks, and is responsible for replication, automatic backup, patch, update, etc.

### Operation of the Proxies to Perform Read/Write-Aware Load Balancing

Referring to FIG. 7, when a database client (not shown; arrow 304 shows incoming connection from a database client) begins a database session, following authentication, to Marathon load balancer 300, a connection 301 is opened to one of the proxies 170. Marathon load balancer 300 maintains health status of the proxies 170, and typically sends connections 301 on a round-robin basis, first to one proxy 170, then to the next, etc. During operation, any of the load-balancing proxies 170 is eligible to receive database queries. A connection is maintained for the length of a database session; i.e. until the database client closes the session, or until the connection is lost, so all queries from a given database client in a given database session typically will be received by the same proxy 170. IP address and role information (whether a database server 202 is a read server or a write server) is stored in etcd 162.

Read/write-aware load balancing is described in detail in the '017 patent, earlier incorporated. A brief overview will be provided here for clarity.

A proxy 170 treats an SQL statement received from a database client as a text string and parses it. The proxy 170 determines whether the SQL statement is a read query or a write query. SQL statements can be divided into two types: queries that read data (or metadata) from the database and do not alter the database, and queries that can alter the database. For example, typically a SELECT type query is a read query because it cannot alter the database. An INSERT query or an UPDATE query is treated as a write query because it can alter the database. It will be appreciated that not all queries that can alter the database actually will alter the database, since that might depend on such things as the result of a WHERE clause in the statement. Nonetheless, as used herein, a query is considered to be a “write query” so long as it is of a type that can alter the database, while a “read query” is not of a type that can alter the database.

If the query is determined to be a write query, it is sent to the write server 202. The write server 202 is identified by its role in etcd store 162. If the query is determined to be a read query, the proxy 170 determines if the results of the query are already stored in cache. If so, the results are returned from cache. If not, the query is forwarded to a read server 202, also identified by its role in etcd store 162. In the case in which a read query is forwarded to a read server 202, the returned response is stored in cache for future use. If necessary, a write server 202 can handle a read query as well.

Each proxy 170 consults etcd 162 to determine which server to establish a connection to. On receiving a read query, the proxy 170 will establish a connection 302 to one of the read servers 202; such a connection 302 is shown between proxy 170 on node C and read server 202 on node A. All read queries in the database session will be forwarded via that connection 302 to the same read server 202. On receiving a write query, the proxy 170 will establish a connection to the write server 202, and all write queries in the database session will be forwarded via that connection to the write server 202; such a connection 302 is shown between proxy 170 on node C and write server 202 on the same node.

If there are no connections available, queries are stored in a queue until a connection comes available. Each proxy 170 has its own query queue.

In alternative embodiments, rather than maintaining the same connection between the proxy and the same database read server for all read queries during a database session, the proxy can drop the connection following completion of a read query, and balance queries between read servers according to workload. The ability to load balance between read servers according to workload may make the additional overhead entailed by dropping and remaking the connections worthwhile.

### Health Monitoring, Failover, Role Updates

The distributed system described herein allows for improved failover, with failures invisible to the database client.

Still referring to FIG. 7, health monitor 204 is in constant communication with database servers 202, and uses etcd 162 to store information regarding failure of any database servers 202 in the database cluster.

If one of the database servers 202 fails, and the failed server is a read server, health monitor 204 tags it as unavailable in the etcd store 162, and no read queries are sent to that read server 202 until it is again available and its status is updated in etcd 162. (Health monitor 204 writes to the etcd 162 on the same virtual machine, virtual machine A in this example, and updated information is immediately mirrored to the other etcd stores 162 in the etcd cluster.) The proxies 170 refer to etcd 162 to find the role, status, and IP address information for database servers 202. If the write server 202 fails, health monitor 204 marks it as unavailable in etcd 162 and selects one of the read servers to be the write server, changing its role until further notice. The proxies 170 read the updated role from etcd 162, and read and write traffic is routed appropriately according to the changed roles of the servers.

In some cases, proxy 170 may be the first to discover that a read or write server 202 has failed by receiving an error in response to a query before health monitor 204 has noted and recorded the failure. In this case proxy 170 can write to etcd 162 to update the health status of the failed database server 202.

Marathon load balancer 300 keeps track of the health of proxies 170, typically alternating connections first to one proxy 170, then to the next, etc. If Marathon load balancer 300 detects that a proxy 170 has failed, it routes traffic to a different proxy 170 until the failed proxy or a new proxy is available. Failover is handled transparently, so that failure of either a database server 202 or a proxy 170 is not apparent to the database client, and requires no action on the part of the database client.

In prior, non-DBaaS implementations of the proxy described herein, there were exactly two proxies, which were implemented in an active/passive model. One proxy was active and handled all traffic, while the second was passive, and became active only in case of a failure of the active proxy. All state information about the database servers, such as role and health information, was stored within the active proxy. The infrastructure available in the DCOS allows for the more efficient active/active configuration of proxies shown in FIG. 7, implemented in the DBaaS with read/write-aware load balancing described herein. The active/active model also allows for more than two proxies, which may be optimal with a large cluster, or when high availability is critical.

### Query Caching

As described in detail in the Singh et al. patents earlier incorporated, the proxies 170 may perform additional tasks beyond read/write-aware load balancing. For example, as described in the '544 patent, a proxy 170 may have access to cache memory. A proxy 170 may receive, through a network port, a first SQL database query, determine whether the first SQL database query is one for which valid response data is already cached in the cache memory, return the response data from the cache memory if so, and, if not, then forward the first SQL database query through a network port toward one or more of the database servers 202. If appropriate, the query results, with indications of the query, are then stored in the cache for future use.

In embodiments, each proxy 170 maintains its own independent cache for holding cached responses. When a proxy 170 receives a query, it checks its cache to see if valid response data is already cached, and, if so, returns the cached response. It does not check the cache of any other proxy 170.

In an alternative embodiment, a single cache may be shared between proxies 170.

### Subsequent Databases

The database user can create new databases as desired. Multiple databases may be created and may exist at the same time, each with a separate port and IP address. A database service can be modified after its creation, for example by manually adding or removing database servers or proxies.

When a database service is no longer needed, the database user can use a dbaascli command to destroy it. In one embodiment, the following command destroys a database service:

$dbaascli dbaas db_service delete

Additional parameters identify the user providing the command and the service to be destroyed. Referring to FIG. 4, the command is relayed from dbaascli 112 to public API 150, which uses vault 152 and Account DB 154 to verify the user. Proxies 170 (shown in FIG. 7) are unregistered from Marathon load balancer 300, and are no longer accessible. Database servers 202, proxies 170, and health monitor 204 are shut down.

While an application is being developed, the application developer can make decisions about the template, for example by causing a template to be customized to include files defining schema and seed data, or by choosing a different template entirely as the needs of the application grow. Once application development is complete, the application may move into a testing phase, where the template selected and/or customized by the application developer is used during testing.

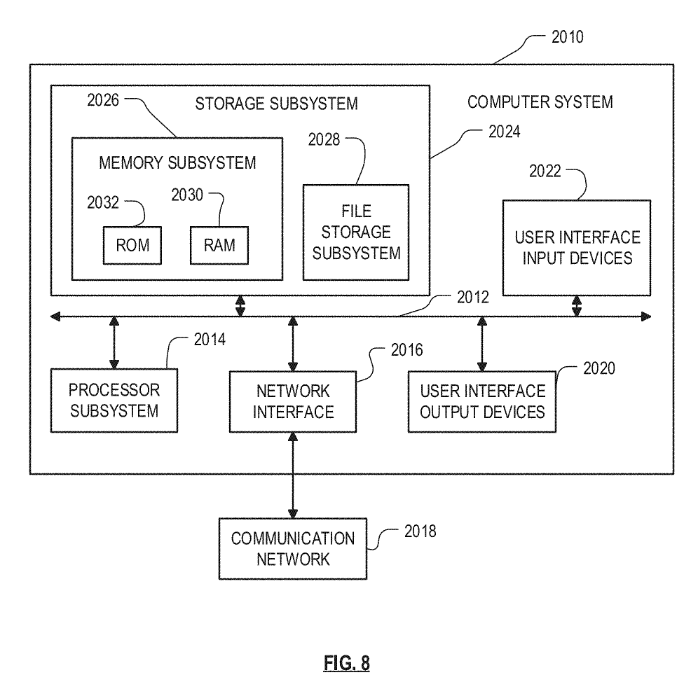

FIG. 8 is a simplified block diagram of a computer system 2010 that can be used to implement any portion of the DBaaS with read/write-aware load balancing described herein. While FIG. 4 and FIG. 7 indicate individual components as carrying out specified operations, it will be appreciated that each component actually causes some computer system 2010 to operate in the specified manner. There will be multiple computer systems operating in concert to perform the functions of the DBaaS described herein, and of the database services provisioned by it. In some embodiments, different components, such as the proxies 170, the health monitor 204, and the database servers 202, as well as support elements like vault 152, Account DB 154, DC API 156, etc., run on separate physical machines, in which case FIG. 8 represents the hardware on which those components run. In another embodiment the different components run on one or more virtual machines housed together on the same computer system as other virtual machines, in which case FIG. 8 represents software-emulated hardware. It also represents the physical hardware of the machine on which all the virtual machines are running.

Computer system 2010 typically includes a processor subsystem 2014 which communicates with a number of peripheral devices via bus subsystem 2012. These peripheral devices may include a storage subsystem 2024, comprising a memory subsystem 2026 and a file storage subsystem 2028, user interface input devices 2022, user interface output devices 2020, and a network interface subsystem 2016. The input and output devices allow user interaction with computer system 2010. Network interface subsystem 2016 provides an interface to outside networks, including an interface to communication network 2018, and is coupled via communication network 2018 to corresponding interface devices in other computer systems. Communication network 2018 may comprise many interconnected routers, computer systems and communication links. These communication links may be wireline links, optical links, wireless links, or any other mechanisms for communication of information. While in one embodiment, communication network 2018 is the Internet, in other embodiments, communication network 2018 may be any suitable computer network.

The physical hardware component of network interfaces are sometimes referred to as network interface cards (NICs), although they need not be in the form of cards: for instance they could be in the form of integrated circuits (ICs) and connectors fitted directly onto a motherboard, or in the form of macrocells fabricated on a single integrated circuit chip with other components of the computer system.

User interface input devices 2022 may include a keyboard, pointing devices such as a mouse, trackball, touchpad, or graphics tablet, a scanner, a touch screen incorporated into the display, audio input devices such as voice recognition systems, microphones, and other types of input devices. In general, use of the term “input device” is intended to include all possible types of devices and ways to input information into computer system 2010 or onto computer network 2018.

User interface output devices 2020 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 2010 to the user or to another machine or computer system.

Storage subsystem 2024 stores the in-memory cache and the persistent cache backup. Either or both of these can be multi-tiered. Storage subsystem 2024 also stores the basic programming and data constructs that provide the functionality of certain embodiments of the present invention. For example, the various modules implementing the functionality of certain embodiments of the invention may be stored in storage subsystem 2024. These software modules are generally executed by processor subsystem 2014.

Memory subsystem 2026 typically includes a number of memories including a main random access memory (RAM) 2030 for storage of instructions and data during program execution and a read only memory (ROM) 2032 in which fixed instructions are stored. File storage subsystem 2028 provides persistent storage for program and data files, including the persistent cache backup, and may include a hard disk drive, a floppy disk drive along with associated removable media, a CD ROM drive, an optical drive, a solid state drive, or removable media cartridges. The databases and modules implementing the functionality of certain embodiments of the invention may have been provided on a computer readable medium such as one or more CD-ROMs, and may be stored by file storage subsystem 2028. The host memory 2026 contains, among other things, computer instructions which, when executed by the processor subsystem 2014, cause the computer system to operate or perform functions as described herein. For example, a non-transitory computer-readable medium may have stored on it a plurality of code portions which, when executed by a processor, perform the method for on-demand creation of a database service described herein.

As used herein, processes and software that are said to run in or on “the host” or “the computer”, execute on the processor subsystem 2014 in response to computer instructions and data in the host memory subsystem 2026 including any other local or remote storage for such instructions and data.

Bus subsystem 2012 provides a mechanism for letting the various components and subsystems of computer system 2010 communicate with each other as intended. Although bus subsystem 2012 is shown schematically as a single bus, alternative embodiments of the bus subsystem may use multiple busses.

Computer system 2010 itself can be of varying types including a personal computer, a portable computer, a workstation, a computer terminal, a network computer, a television, a mainframe, a standalone appliance, or any other data processing system or user device. Due to the ever-changing nature of computers and networks, the description of computer system 2010 depicted in FIG. 8 is intended only as a specific example for purposes of illustrating embodiments of the DBaaS system described herein. Many other configurations of computer system 2010 are possible having more or less components than the computer system depicted in FIG. 8.

As used herein, a given event is “responsive” to a predecessor event if the predecessor event influenced the given event. If there is an intervening processing element, step or time period, the given event can still be “responsive” to the predecessor event. If the intervening processing element or step takes input from more than one predecessor event, the output of the processing element or step is considered “responsive” to each of the event inputs. If the given event is the same as the predecessor event, this is merely a degenerate case in which the given event is still considered to be “responsive” to the predecessor event. “Dependency” of a given event upon another event is defined similarly.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the present invention may consist of any such feature or combination of features. In view of the foregoing description it will be evident to a person skilled in the art that various modifications may be made within the scope of the invention.

The foregoing description of preferred embodiments of the present invention has been provided for the purposes of illustration and description. It is not intended to be exhaustive or to limit the invention to the precise forms disclosed. Obviously, many modifications and variations will be apparent to practitioners skilled in this art. In particular, and without limitation, any and all variations described, suggested or incorporated by reference in the Background section of this patent application are specifically incorporated by reference into the description herein of embodiments of the invention. The embodiments described herein were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. A method for on-demand creation of a database service, the method comprising:
in response to receiving indication from a user that the database service is to be created, initiating an automated process including:
instantiating in a virtual environment a quantity of database servers, a first subset of at least one of the database servers being designated to handle read queries only and a second subset of at least one of the database servers being designated to handle write queries;
determining a quantity and size of load-balancing proxies to instantiate for supporting the database server instances; and
instantiating the determined quantity of load-balancing proxies of the determined size,
wherein at least one of the load-balancing proxies is a proxy configured to receive database queries and perform query routing among the first subset and the second subset, wherein one criterion for said query routing is whether a given query is a read query or a write query.

2. The method of claim 1 wherein the indication from the user includes identification of a template, the template indicating a performance level for the database service.

3. The method of claim 2 wherein the template indicates performance level by specifying a quantity of database server instances to create and a quantity of CPUs to allocate per database server instance.

4. The method of claim 1 wherein the at least one load-balancing proxy comprises a cache memory and is further configured to:
receive, through a network port, a first SQL database query;
determine whether the first SQL database query is one for which valid response data is already cached in the cache memory;
return the response data from the cache memory if so;
and, if not, then forward the first SQL database query through a network port toward one or more of the database servers.

5. The method of claim 1 wherein the automated process, including instantiating the quantity of database servers, determining the quantity of load balancing proxies to instantiate for supporting the database server instances, and instantiating the determined quantity of load balancing proxies, is performed without ongoing direction by the user or a service provider.

6. The method of claim 5 wherein the automated process is modified by parameters supplied with the indication that the database service is to be created.

7. The method of claim 1 further comprising seeding the database service with seed data.

8. The method of claim 1 further comprising instantiating a health monitor which monitors the health of the database servers and proxies and stores health information in a store accessible by the proxies.

9. The method of claim 1 wherein, during operation, any of the load-balancing proxies is eligible to receive database queries.

10. A non-transitory computer-readable medium having stored thereon a plurality of code portions which, when executed by a processor, perform a method for on-demand creation of a database service, the method comprising:
in response to receiving indication from a user that the database service is to be created, initiating an automated process including:
instantiating in a virtual environment a quantity of database servers, a first subset of at least one of the database servers being designated to handle read queries only and a second subset of at least one of the database servers being designated to handle write queries;
determining a quantity of load-balancing proxies to instantiate for supporting the database server instances; and
instantiating the determined quantity of load-balancing proxies,
wherein at least one of the load-balancing proxies is a proxy configured to receive database queries and perform query routing among the first subset and the second subset, wherein one criterion for said query routing is whether a given query is a read query or a write query.

11. The computer-readable medium of claim 10 wherein the indication from the user includes identification of a template, the template indicating a performance level for the database service.

12. The computer-readable medium of claim 11 wherein the template indicates performance level by specifying a quantity of database server instances to create and a quantity of CPU cores to allocate per database server instance.

13. The computer-readable medium of claim 10 wherein the at least one load-balancing proxy comprises a cache memory and is further configured to:
receive, through a network port, a first SQL database query;
determine whether the first SQL database query is one for which valid response data is already cached in the cache memory;
return the response data from the cache memory if so;
and, if not, then forward the first SQL database query through a network port toward one or more of the database servers.

14. The computer-readable medium of claim 10 wherein the automated process, including instantiating the quantity of database servers, determining the quantity of load balancing proxies to instantiate for supporting the database server instances, and instantiating the determined quantity of load balancing proxies, is performed without ongoing direction by the user or a service provider.

15. The computer-readable medium of claim 14 wherein the automated process is modified by parameters supplied with the indication that the database service is to be created.

16. The computer-readable medium of claim 10 wherein the method further comprises seeding the database service with seed data.

17. The computer-readable medium of claim 10 wherein the method further comprises instantiating a database monitor which monitors the health of the database server and proxies and stores health information in a store accessible by the proxies.

18. The computer-readable medium of claim 10 wherein, during operation, any of the load-balancing proxies is eligible to receive database queries.
